(19) United States
(12) Patent Application Publication
(10) Pub. No.: US 2009/0291859 A1
(43) Pub. Date: Nov. 26, 2009

(54) Drilling fluid additive

(76) Inventor: Michael Valls, New Iberia, LA (US)

Correspondence Address: KEATY LAW FIRM, LLC, 365 CANAL STREET, Suite 2410, NEW ORLEANS, LA, 70130, US

(21) Appl. No.: 12/154,385

(22) Filed: May 22, 2008

(51) Int. Cl. C09K 8/03

(52) U.S. Cl. 507/103

(57) ABSTRACT

A water base drilling fluid additive contains biodiesel, lime, calcium chloride and solids for improving viscosity of the drilling fluid, while containing biodegradable ingredients. The additive also contains a weighting agent, for instance barite, a well bore sealant, such as bentonite, and an emulsion stabilizer, such as is lignosulfonate.

### CROSS-REFERENCE TO RELATED APPLICATIONS

This application is a non-provisional application based on my provisional application Ser. No. 60/928,180 filed on May 8, 2007 entitled “A Drilling Mud Additive,” the full disclosure of which is incorporated by reference herein.

### BACKGROUND OF THE INVENTION

The present invention relates to a composition of matter for use in a drilling fluid, and more particularly to a biodegradable non-toxic drilling fluid additive containing biodiesel.

For many years, researchers and technologists have been researching the use of biofuels as alternatives or additives to currently used petroleum-based fuels and lubricants. Biofuels can be derived from a variety of sources. For instance, vegetable oils methyl esters have been investigated as a substitute for gasoline-based fuel. It is expected that this type of fuel will expand in the future. It was suggested that the presence in vegetable oil of trace monoglycerides makes it possible to compensate for the loss of lubricant power due in particular to the reduction in the sulphur content of the gasoline-based fuel.

The present invention proposes to use biofuels as a substitute for hydrocarbon-based components in well bore operations, and more particularly as lubricants in drilling operations during mineral exploration. Conventionally, drilling mud is used during wellbore drilling operations. The mud is pumped into the wellbore surrounding the drilling tool. The mud serves several purposes—it acts as a lubricant, buoyant medium, coolant and helps in the cuttings removal. The mud is usually kept overbalanced, i.e. at a higher pressure than the pressure of the formation fluids. This leads to “invasion” of the mud into the formation and the buildup of mudcake on the borehole wall. Various types of drilling fluid or mud have been used in the past, such as water-based fluids containing water and additives to increase viscosity, oil fluids and water-in-oil or oil-in-water type emulsions.

Various lubricants and lubricating agents have been used in drilling applications and in aqueous based drilling fluids. Surfactants, solid materials like glass beads, graphite, hydrocarbons like polyalphaolefins, synthetic and natural oils like glycols, fatty acid esters have all been reported in the literature as being useful in aqueous based drilling fluids for use as lubricants. Some of these substances are not soluble or compatible with aqueous based drilling fluids. Most of these lubricants, whether soluble or insoluble, require significant concentration to perform as lubricants.

One of the known drilling mud additives is sold under a brand name “Black Magic” and is manufactured by Baker Hughes of Aberdeen, U.K. According to the manufacturer, it is important that the manufacturing process include three steps, namely pre-filtration, reaction and purification. The Baker Hughes drilling fluid contains 60-100 wt % asphalt fumes, 5-10 wt % alkyl aryl sulphonic acid, 20-40 wt % calcium hydroxide, 0.-0.1 wt % hydrogen sulfide, and 1-5 wt % diatomaceous earth. This product is a solid substance having a gray color, hydrocarbon odor and specific gravity of 1.02 g/m; it is slightly soluble in water.

In contrast to hydrocarbon-based drilling mud additives, biofuels, including biodiesel are water-soluble. Biodiesel is made through a chemical process called transesterification, whereby the glycerin is separated from the fat or vegetable oil. The process leaves behind two products—methyl esters (the chemical name for biodiesel) and glycerin (a byproduct usually used in soaps and other products).

The present invention contemplates elimination of drawbacks associated with conventional hydrocarbon-based drilling fluids and provision of a biodegradable drilling fluid additive.

### SUMMARY OF THE INVENTION

It is therefore, an object of the present invention to provide a drilling fluid additive that has high lubricity suitable for use in drilling mud compositions.

It is another object of the present invention to provide a drilling fluid additive that facilitates the drilling process, while being suitable for release into the soil or ocean waters.

These and other objects of the present invention are achieved through a provision of a drilling mud additive substance that contains water-soluble, biodegradable methyl esters having sufficient lubricity for use as the oil phase of a water-base drilling fluid. The additive is made from vegetable oil processed to separate methyl esters and glycerin.

The composition of matter according to the present invention comprises biodiesel, solids suspended in water, as well as small quantities of lime, lignosulfonate, calcium chlorides, bentonite and barite. Biodiesel is substantially a transesterfied fat, produced from any of acceptable animal fat or vegetable oil source, for instant seed oil, fish oil, Jatropha oil, waste vegetable oil, algae oil, trap grease, brown grease. Preferably, the biodiesel used in the instant invention meets or exceeds the qualification of ASTM D 6751 methyl ester.

### DETAILED DESCRIPTION OF THE PREFERRED EMBODIMENT

The composition of the drilling mud additive of the present invention is designed to be used in a well bore environment to facilitate drilling in a subterranean formation. According to the present invention, the composition of matter comprises between 60 and 66% by volume of biodiesel, between 7 and 10% by volume of solids suspended in water (15-24% by volume), between 1 and 6% by volume of calcium chloride, about 1% by volume of lime and a similar amount of an emulsion stabilizer, such as lignosulfonate, a well bore sealant, such as bentonite present in an amount of about 5% by volume and a weighting agent that increases viscosity of the drilling fluid. This weighting agent can be barite present in an amount of about 2% by volume.

The biodiesel component comprises short chain alkyl (methyl or ethyl) esters, which were derived from processing animal fat or vegetable oil. In the preferred embodiment the biodiesel component is a standardized methyl ester. One example is a soybean methyl ester with a molecular weight of 292.2; it may contain several fatty acids, such as palmitic, stearic, oleic, linoleic, and linolenic acids. The methyl ester can be also a commercially available palm methyl ester, rapeseed methyl ester, and others.

The lime component can be a material derived from limestone or chalk and is composed primarily of calcium carbonate, but can also contain oxides and/or hydroxides of calcium.

The solids component can be crushed rock, sand, silicate, microscopic particles of earth or cuttings that were retained in a shale shaker conventionally used in the mineral exploration industry. These particles are usually micron-sized and can be used to increase viscosity.

Lignosulfonate component is a highly anionic polymer used to deflocculate clay-based muds. Lignosulfonate is a byproduct of the sulfite method for manufacturing paper from wood pulp. Sometimes it is called sulfonated lignin. Lignosulfonate is a complex mixture of small- to moderate-sized polymeric compounds with sulfonate groups attached to the molecule. Lignosulfonates are emulsion stabilizers and are not soluble in the organic liquids but adsorb at the oil-water interfacial surface. They reduce surface tension thereby lowering the energy required to form small droplets of the water-containing mud additive. By forming a continuous coating, the lignosulfonate generates an effective steric barrier and since they are charged they also effect electrostatic repulsion, thereby further reducing the likelihood the drops will come into intimate contact.

The calcium chloride (CaCl2) component is a water-soluble hygroscopic ionic compound of calcium and chlorine. It is commercially available in solid form. The salt can be derived from limestone.

The bentonite component is can be a sodium bentonite or calcium bentonite. Sodium bentonite expands when wet, possibly absorbing several times its dry mass in water. The property of swelling also makes sodium bentonite useful as a sealant, especially for the sealing of subsurface formation since it tends to build a slurry wall and forming an impermeable barrier: e.g., to seal off the annulus of a well bore. Calcium bentonite may be converted to sodium bentonite and exhibit sodium bentonite's properties by a process known as “ion exchange”. Commonly this means adding 5-10% of sodium carbonate to wet bentonite, mixing well, and allowing time for the ion exchange to take place. Relatively small quantities of bentonite suspended in water of the instant composition can form a viscous, shear thinning material that aids in the formation of mud cake in the drilling mud.

The barite component (BaSo₄) is a mineral consisting substantially of barium sulfate. Barite is commercially available as solid substance ground to a small, uniform size. In the instant composition it is used as a weighting agent.

All components of the instant composition are mixed before they are added to a mud tank and slugging pit. The mud viscosity is determined by gel strength. 40-60 viscosity is a normal range. The mud weight is determined by adding or reducing the biodiesel and conversely adding or deleting solids (cuttings), barite, bentonite and/or calcium chloride. Increasing the percentage of solids would be another way of elevating the mud weight.

It is envisioned that adding biodiesel can also reduce the mud weight, preferably within a range of between 10 lbs/gal to 18 lbs/gal. The higher the mud weight per gallon the higher the viscosity.

The present invention contemplates provision of a process for improving the viscosity or the solids suspension properties of a water base drilling fluid containing solids to increase the drilling fluid density by introducing into the well the drilling mud (fluid), to which an drilling fluid additive was added. The drilling fluid additive comprises between about 60 and 66% by volume of biodiesel, between 7 and 10% by volume of solids suspended in water, between 1 and 6% by volume of calcium chloride, about 1% by volume of lime and an equal amount of lignosulfonate, about 5% by volume of bentonite and about 2% by volume of barite.

One of the advantages of the biodiesel additive of the present invention is that is helps reduce the fluid loss in a well bore. The liquid phase of the additive coats the colloidal materials in the mud system, which in turn forms a slippery shield on the wall cake of the borehole and prevents the liquid from escaping into the formation. Additionally, the solid phase of the additive plugs micro fractures in the formation zones where seepage loss is likely to occur. Compared to conventional drill fluids, the additive of the present invention uses several times less volume in combating the fluid loss.

The high lubricity of the additive according to the present invention increases the drill rate and enhances sliding of the drill bit. The fluid loss is significantly reduced with the formation of a slick thin filter cake, which in turns makes it less likely for the occurrence of a stuck pipe. A flowable drill mud additive of this invention has lubricating properties that are superior to the oil-based mud being twelve times more lubricating than currently available commercial drilling mud additives. An additional advantage of this composition is that biodiesel has a higher flash point (in the order of 302 degrees Fahrenheit) than fossil fuel diesel (176 degrees Fahrenheit). Because all ingredients are biodegradable the drilling mud additive of the invention is not expected to adversely affect the surrounding environment.

It is envisioned that the drill fluid additive of the present invention can be manufactured at an optimal cost compared to fluids based on synthetic oils.

I claim:

1. A water base drilling fluid additive, comprising water, solids and between 60 and 66% by volume of biodiesel.

2. The drilling fluid additive of claim 1, wherein said solids is present in an amount of between 7 and 10% by volume.

3. The drilling fluid additive of claim 1, further comprising an emulsion stabilizer, calcium chloride, lime, a well bore sealant, and a weighting agent for increasing viscosity of the drilling fluid.

4. The drilling fluid additive of claim 3, wherein said emulsion stabilizer is lingosulfonate present in an amount of about 1% by volume.

5. The drilling fluid additive of claim 3, wherein said weighting agent is barite present in an amount of about 2% by volume.

6. The drilling fluid additive of claim 3, wherein said well bore sealant is bentonite present in an amount of about 5% by volume.

7. The drilling fluid additive of claim 3, further comprising calcium chloride present in an amount of between about 1 and 6% by volume.

8. The drilling fluid additive of claim 3, further comprising lime present in an amount of about 1% by volume.

9. A process for improving the viscosity or the solids suspension properties of a water base drilling fluid containing solids to increase the drilling fluid density which comprises the steps of adding to said fluid an amount of between about 60 and 66% by volume of biodiesel, between 7 and 10% by volume of solids suspended in water, between 1 and 6% by volume of calcium chloride, about 1% by volume of lime and an equal amount of emulsion stabilizer, about 5% by volume of a well bore sealant agent and about 2% by volume of a weighting agent.

10. The process of claim 9, wherein said emulsion stabilizer is lignosulfonate.

11. The process of claim 9, wherein said well bore sealant agent is bentonite.

12. The process of claim 9, wherein said weighting agent is barite.

13. A drilling fluid which comprises water, solids to increase the drilling fluid density and an additive comprising between 60 and 66% by volume of biodiesel, between 7 and 10% by volume of solids suspended in water, between 1 and 6% by volume of calcium chloride, about 1% by volume of lime, about 1% by volume of emulsion stabilizer, about 5% by volume of well bore sealant, and about 2% by volume of a weighting agent.

14. The drilling fluid of claim 13, wherein said emulsion stabilizer is lignosulfonate

15. The drilling fluid of claim 13, wherein said well bore sealant is bentonite.

16. The drilling fluid of claim 13, wherein said weighting agent is barite.
